(19) United States
(12) Patent Application Publication
(10) Pub. No.: US 2008/0056542 A1
(43) Pub. Date: Mar. 6, 2008

(54) Face-detection-based remote-control system and method and face-detection-based remote-controllable multimedia system

(75) Inventors: Chien-Yu Hung, Banciao City (TW); Chia-Hua Chang, Taipei City (TW)

Correspondence Address: RABIN & Berdo, PC, 1101 14TH STREET, NW, SUITE 500, WASHINGTON, DC, 20005, US

(73) Assignee: Ulead Systems, Inc.

(21) Appl. No.: 11/646,341

(22) Filed: Dec. 28, 2006

(30) Foreign Application Priority Data
Aug. 30, 2006 (TW) 95131985

(51) Int. Cl. G06K 9/00

(52) U.S. Cl. 382/118

(57) ABSTRACT

Face-detection-based remote-control system and method and face-detection-based remote-controllable multimedia system are disclosed. The face-detection-based remote-control method includes the following steps. (a) By using a detection device, detection of at least one part of an existing face is made according to an operation mode of the multimedia system in order to output a face image signal. (b) According to the face image signal, analysis of at least the part of the existing face detected is performed to generate at least a characteristic parameter correspondingly. (c) Comparing at least the characteristic parameter to at least a conditional parameter is made to generate a comparison result, wherein the conditional parameter is associated with at least a control action of the operation mode. (d) According to the comparison result, at least an indication signal is generated to the multimedia system.

This application claims the benefit of Taiwan application Serial No. 95131985, filed Aug. 30, 2006, the subject matter of which is incorporated herein by reference.

### BACKGROUND OF THE INVENTION

1. Field of the Invention

The invention relates in general to a remote-control system and a method thereof and a remote-controllable multimedia system, and more particularly to a face-detection-based remote-control system and a method thereof and a face-detection-based remote-controllable multimedia system.

2. Description of the Related Art

Multimedia systems, such as televisions and digital video disk (DVD) players, conventionally provide remote control functionality for users to control the multimedia systems, e.g. setting the systems or playing multimedia data such as displaying television programs or DVD movies, remotely through a corresponding remote controller in a wired or wireless manner within a predetermined distance.

However, from the viewpoint of the users, the necessity of a remote controller for controlling the multimedia system conventionally causes the following problems. First, the remote controller inevitably requires many keys provided on a small surface of the remote controller for users to control the multimedia system due to versatile functionality of the system. Secondly, novice users have to spend time learning and then become accustomed to the complicated operations of remote controllers each of which is made based on different operational designs, along with many keys. In addition, it spends time finding the remote controller if it is out of sight. Further, a remote controller needs to be powered by batteries, and unexpected problems would occur if the batteries are out of energy or in a poor state which leads to operational failure or hardware malfunction of the remote controller by the leakage of the chemical solution of the battery.

Hence, it is desirable to control multimedia system remotely more conveniently or avoid the above-mentioned problems, and a distinguishing approach to remote control for multimedia systems is desired for users' convenience.

### SUMMARY OF THE INVENTION

The invention is directed to a face-detection-based remote-control system and method and face-detection-based remote-controllable multimedia system. For the control of a multimedia system, the behavior of some part of the body of a user, such as face and eye behavior, is detected and analyzed to generate at least one characteristic parameter accordingly. At least one characteristic parameter is compared to at least one conditional parameter and the multimedia system is controlled according to the result of the comparison.

According to a first aspect of the present invention, an embodiment of a face-detection-based remote-control method is provided for a multimedia system. The method includes the following steps. (a) At least one part of any existing face is detected by using a detection device according to an operation mode of the multimedia system in order to generate a face image signal. (b) At least the part of the detected existing face is analyzed according to the face image signal to generate at least a characteristic parameter correspondingly. (c) At least the characteristic parameter is compared to at least a conditional parameter to generate a comparison result, wherein the conditional parameter is associated with at least one control operation of the operation mode. (d) At least an indication signal to the multimedia system is generated according to the comparison result.

According to a second aspect of the present invention, an embodiment of a face-detection-based remote-control system is provided for a multimedia system, wherein the multimedia system has an operation mode and the operation mode has at least a control operation. The remote-control system includes a detection device and an image-analyzing-and-indication-generating unit. The detection device is used for detecting at least one part of any existing face according to the operation mode in order to generate a face image signal. The image-analyzing-and-indication-generating unit, coupled to the detection device, is used for analyzing at least the part of the detected existing face according to the face image signal in order to generate at least a characteristic parameter correspondingly, which is compared with at least a conditional parameter to generate a comparison result. At least an indication signal to the multimedia system is then generated according to the comparison result. The conditional parameter is associated with at least one control operation of the operation mode.

According to a third aspect of the present invention, an embodiment of a face-detection-based remote-control system is provided. The multimedia system has an operation mode and the operation mode has at least a control operation. The multimedia system includes a detection device, an image-analyzing-and-indication-generating unit, and a playing device. The detection device is used for detecting at least one part of any existing face according to the operation mode in order to generate a face image signal. The image-analyzing-and-indication-generating unit, coupled to the detection device, is used for analyzing at least the part of the detected existing face according to the face image signal in order to generate at least a characteristic parameter correspondingly, which is compared with at least a conditional parameter to generate a comparison result. At least an indication signal to the multimedia system is then generated according to the comparison result. The conditional parameter is associated with at least one control operation of the operation mode. The playing device is used for playing multimedia data according to at least the indication signal.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram illustrating a multimedia system according to an embodiment of the invention, wherein the multimedia system includes an embodiment of a face-detection-based remote-control system.

FIG. 2 shows another embodiment of a face-detection-based remote-controllable multimedia system according to the invention.

FIG. 3 is a flowchart illustrating a face-detection-based remote-control method according to a preferred embodiment of the invention.

FIG. 4A is a flowchart illustrating a face-detection-based remote-control method applied to a multimedia system in a playing mode according to an embodiment of the invention.

FIG. 4B is a flowchart illustrating an embodiment of step 440 indicated in FIG. 4A for generating an indication signal to the multimedia system.

FIG. 5 illustrates a face-detection-based remote-control system applied to a multimedia system in a menu mode according to an embodiment of the invention.

### DETAILED DESCRIPTION OF THE INVENTION

According to the invention, the behavior of at least a part of the human body, e.g. the head including the face or any part of the face such as eyes, chin, mouth, lips, nose, ear, cheek, hair, beard, or any combination thereof, is associated with remote control operations of a multimedia system, and such association is the basis of generating an indication signal to the multimedia system, resulting in changing the operation behavior of the multimedia system. In this way, the multimedia device can be operated more easily and directly. In addition, an intelligent remote-control method can be developed according to the invention and applied in a remote-control system to generate an indication signal, in response to detection results obtained in a situation, so as to control the operation of the multimedia device, without the need of giving direct commands by the user. The following embodiments illustrate different ways to implement the invention, wherein face and eye behavior, for example, is associated with the remote control operation of the multimedia system, such as playing contents or changing setting of the multimedia system.

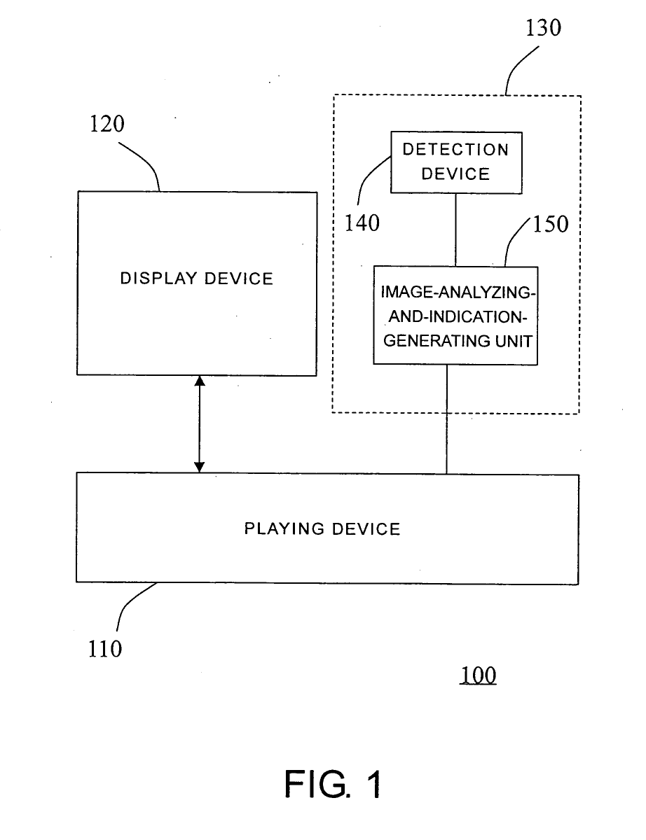

FIG. 1 is a block diagram illustrating a multimedia system according to an embodiment of the invention, wherein the multimedia system includes an embodiment of a face-detection-based remote-control system. The multimedia system 100 includes a playing device 110, a display device 120, and a remote-control system 130.

The multimedia system 100 is a system for processing multimedia data or contents and reproducing the multimedia contents accordingly. The multimedia system 100 has at least one operation mode, e.g. a playing mode, and the operation mode has at least one control operation, such as playing, pausing, or stopping. As another example, the multimedia system 100 has a menu mode and the menu mode has at least one menu selection operation, and the menu selection operation is used for setting or controlling the multimedia system 100. At least one conditional parameter is associated with at least one control operation.

The remote-control system 130 generates an indication signal according to the behavior of a person, based on the face or at least one part of the face, to change the operation of the multimedia system 100. The remote-control system 130 includes a detection device 140 and an image-analyzing-and-indication-generating unit 150. The remote-control system 130 can make use of one or more detection or tracking techniques, such as object detection, object tracking, human face detection or any combination thereof, to detect the behavior of any person existing.

The detection device 140 is a device for detecting human bodies or acquiring images, such as a charge-coupled device (CCD), a digital camera, a webcam, or a digital video capture device. The detection device 140 is used for detecting any existing face or at least one part of any existing face according to an operation mode of the multimedia system in order to generate a face image signal. The detection device 140 is configured to perform, for example, auto-zooming, human face feature acquisition, or eyeballs tracking and location.

The image-analyzing-and-indication-generating unit 150 is coupled to the detection device 140 and is used for analyzing at least the part of the detected existing face according to the face image signal to generate at least one characteristic parameter correspondingly. In addition, the image-analyzing-and-indication-generating unit 150 is further used to determine whether to generate at least an indication signal to the multimedia system 100 according to the at least one characteristic parameter and at least one conditional parameter. For implementation, the image-analyzing-and-indication-generating unit 150 compares at least the characteristic parameter to at least the conditional parameter associated with at least one control operation of the operation mode in order to generate a comparison result, and generates at least an indication signal to the multimedia system according to the comparison result. For example, the image-analyzing-and-indication-generating unit 150 can be implemented with or include a digital image processor, such as a digital image acquisition device, or a microprocessor, or a system-on-chip. In addition, the image-analyzing-and-indication-generating unit 150 can include memory for storing data.

The playing device 110, such as a DVD player, a digital recording/reproducing device, or a multimedia player compliant with a wireless network. The playing device 110, in response to at least the indication signal, is used for processing multimedia data. The playing device 110 can also be configured or set according to the indication signal. The playing device 110 processes and outputs multimedia signals. The playing device 110 can be a processing device capable of processing multimedia data, such as a computer system or audio/video player or recorder. The playing device 110 can be implemented and configured to read storage media, such as optical disks, hard disks, or memory cards. The playing device 110 can also be implemented and configured to access digital image, video, or audio data to process or reproduce in either wired or wireless manner.

The display device 120, such as a flat plane display, liquid crystal display, cathode-ray tube display, or projection display, is employed to reproduce video and audio according to the multimedia signal outputted from the playing device 110.

In addition, the playing device 110 and display device 120 can be combined as a unit for multimedia data processing and multimedia reproduction, such as a desktop or notebook computer system, digital television, analog television, or video-conference system.

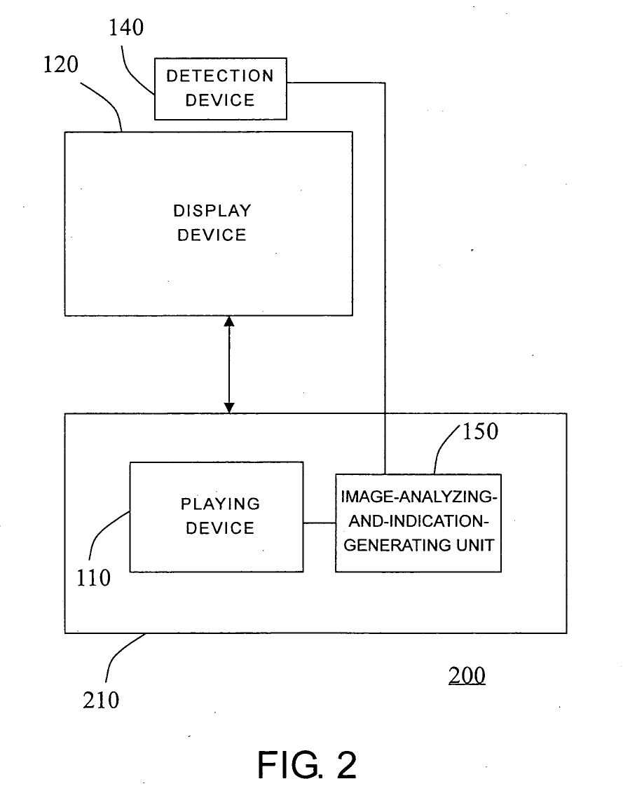

FIG. 2 shows another embodiment of a face-detection-based remote-controllable multimedia system according to the invention. Similar to the one in FIG. 1, the multimedia system 200 includes the playing device 110, display device 120, detection device 140, and image-analyzing-and-indication-generating unit 150.

Unlike the multimedia system 100 in FIG. 1, the playing device 110 and image-analyzing-and-indication-generating unit 150 are included in a host 210 in FIG. 2. In addition, another embodiment of the multimedia system can be obtained according to FIG. 2. For example, the detection device 140 in FIG. 2 is included in the host 210.

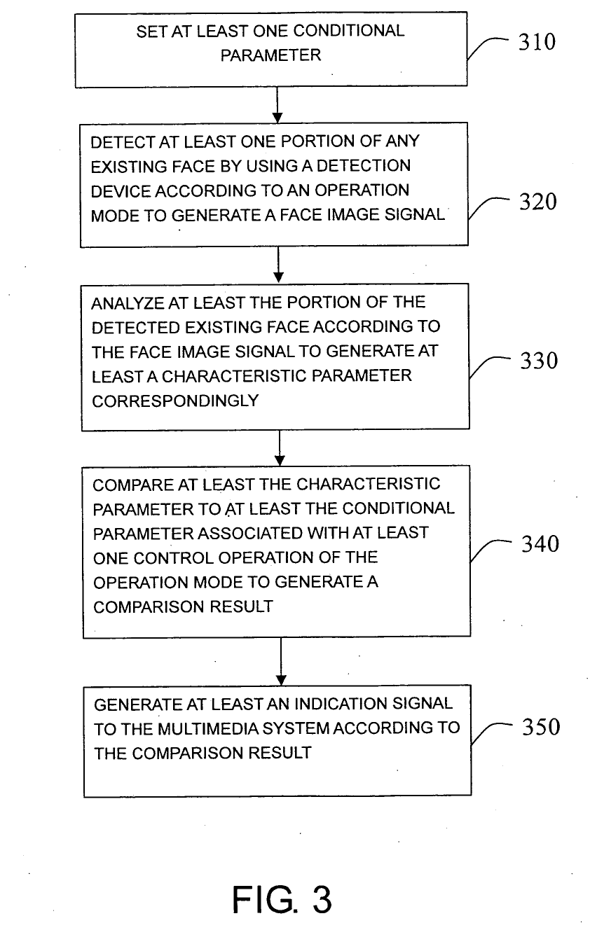

FIG. 3 is a flowchart illustrating a face-detection-based remote-control method according to a preferred embodiment of the invention. The method includes the following steps. First, at least one conditional parameter is set, as indicated in step 310. In step 320, at least one part of any existing face is detected by using a detection device according to an operation mode of the multimedia system in order to generate a face image signal. In step 330, at least the part of the detected existing face is analyzed according to the face image signal in order to generate at least a characteristic parameter correspondingly. In step 340, at least the characteristic parameter is compared to at least the conditional parameter in order to generate a comparison result, wherein the conditional parameter is associated with at least one control operation of the operation mode. Next, an indication signal is generated to the multimedia system according to the comparison result, as indicated in step 350.

In FIG. 3, step 310, which sets at least one conditional parameter, is performed before step 320 and such sequence of the steps is merely an example for implementation. In another example, step 310 can be performed after step 320 or at the same time as step 320. In practice, a conditional parameter in step 310 can be pre-set data, not necessarily being set during the operation of remote control. In another embodiment, the multimedia system sets or modifies one or more conditional parameters according to the requirement of an operation mode in which the multimedia system is operating. Further, conditional parameters can also be determined by a user, for example. Nevertheless, a conditional parameter is associated with at least one control operation of an operation mode of the multimedia system.

In the following embodiments of the invention, the multimedia system may have one or more operation modes. Firstly, a playing mode is taken as an example of the operation mode to illustrate an embodiment of a remote-control method according to the invention. Next, a menu mode is taken as an example of the operation mode to illustrate another embodiment of a remote-control method according to the invention. It is noticed that setting conditional parameters can be implemented in different ways and thus the step of setting conditional parameters in the following embodiments can be performed in different sequences or ways, as above mentioned.

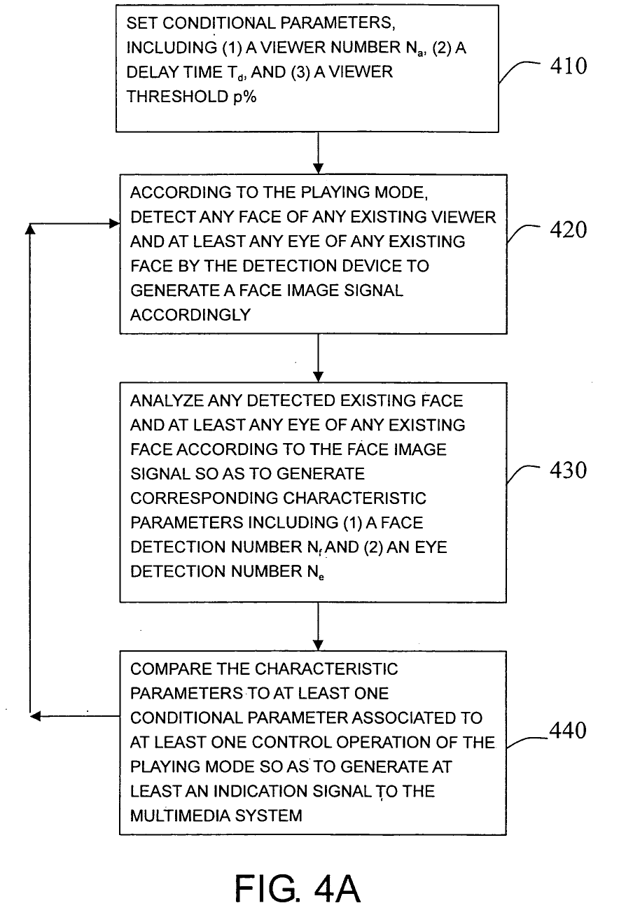

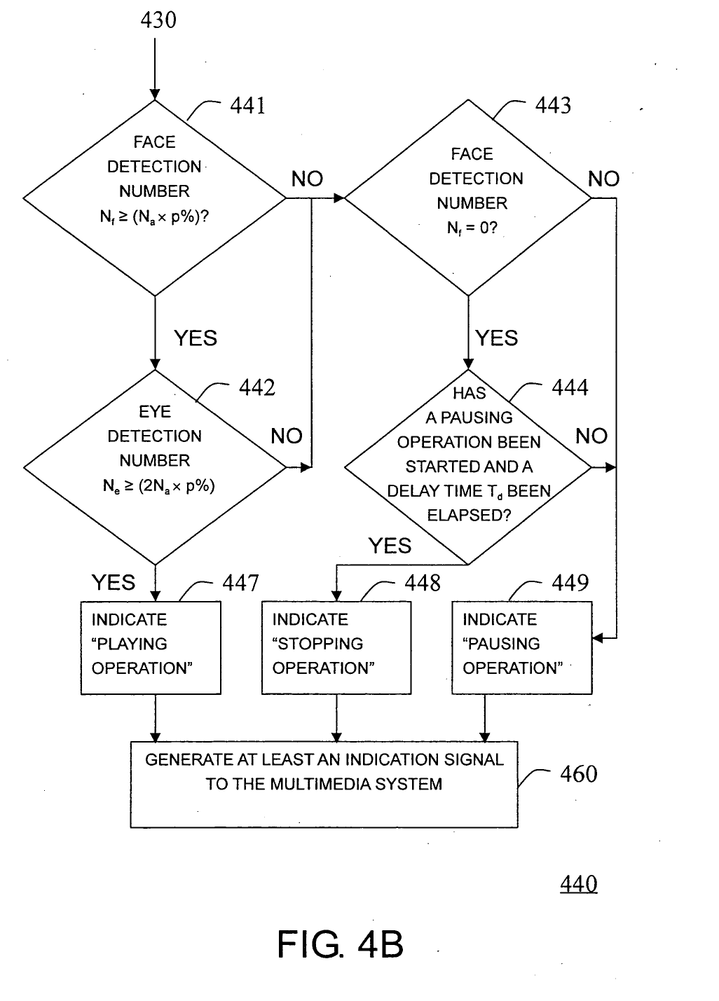

FIG. 4A is a flowchart illustrating a face-detection-based remote-control method applied to a multimedia system in a playing mode according to an embodiment of the invention.

As shown in step 410, a number of conditional parameters are set, including (1) a viewer number Nₐ, (2) a delay time T_{d}, and (3) a remaining viewer threshold p %, and associated with playing, stopping, pausing operations of the playing mode. As indicated in step 420, according to the playing mode, any face of any existing viewer and at least any eye of any existing face is detected by using the detection device so as to generate a face image signal accordingly. In step 430, any detected existing face and at least any eye of any existing face are analyzed according to the face image signal so as to generate corresponding characteristic parameters including (1) a face detection number N_{f} indicating how many faces are detected and (2) an eye detection number Nₑ indicating how many eyes that are opened are detected. As indicated in step 440, the characteristic parameters generated according to the face image signal are compared to at least one conditional parameter associated with at least one control operation of the playing mode so as to generate an indication signal to the multimedia system. In addition, after step 440, the method according to this embodiment can proceed to step 420 to repeat the face and eye detection and to generate indication signals to the multimedia system.

Step 430 of this embodiment takes the face detection number N_{f} and the eye detection number Nₑ as examples of characteristic parameters. Step 440 can be implemented by different ways of comparisons according to the two characteristic parameters to generate at least one indication signal to the multimedia system. Referring to FIG. 4B, an embodiment of step 440 is illustrated in flowchart form. As an example for the sake of explanation, the viewer number Nₐ is 5, the delay time T_{d} is 10 minutes, and the remaining viewer threshold p % is 80% in the following.

In FIG. 4B, as indicated in step 441, it is determined whether the face detection number N_{f} is substantially larger than or equal to a percentage of the viewer number Nₐ, e.g. whether the face detection number N_{f} (say, 4) is larger than or equal to (Nₐ×p %), i.e. (5×0.8)=4. If so, step 442 is performed to determine whether the eye detection number Nₑ is substantially larger than or equal to another percentage of the viewer number Nₐ, e.g. whether the eye detection number Nₑ (say, 8) is larger than or equal to (2Nₐ×p %), i.e. (2×5×0.8)=8 (eyes). If the comparison result in step 442 indicates affirmative, the indication signal indicates performing the playing operation, as indicated in steps 447 and 460.

In step 441 or 442, if the result is negative, step 443 is performed to determine whether the face detection number N_{f} is zero. If so, step 444 is performed to determine whether the pausing operation has been started and the delay time T_{d} has been elapsed. If the result of step 443 or 444 indicates negative, the indication signal indicates performing the pausing operation, as indicated in steps 449 and 460.

If the result of step 444 indicates affirmative (i.e. the pausing operation has been started for at least the delay time T_{d}; e.g. has been started for 11 minutes), the indication signal indicates performing the stopping operation, as indicated in steps 448 and 460.

In FIGS. 4A and 4B, behavior of human beings (i.e. viewers), for example, the behavior of their faces and a part of their faces, is taken as the basis to control the operation or behavior of the multimedia system. For example, when the face detection number N_{f} and the eye detection number Nₑ satisfy a condition for playing, the multimedia system starts playing, as shown in steps 441, 442, 447, and 460. As another example, when some viewers leave their seats and the number of the viewers who leave is large, the multimedia system starts pausing, as shown in steps 443, 444, 449, and 460. In addition, if the pausing remains for the delay time T_{d} (e.g. after 10 minutes) while the face detection number N_{f} and the eye detection number Nₑ still do not satisfy a condition for resuming from pausing, the multimedia system stops the playing, as shown in steps 444, 448 and 460.

In the embodiments illustrated by FIGS. 4A and 4B, three conditional parameters and two characteristic parameters are taken as examples to show how to change the operation or behavior of the multimedia system according to behavior of any detected viewer. In addition, at least one conditional parameter can also be used to change the operation or behavior of the multimedia system, based on any detected face or at least one part of any detected face. In one embodiment, any face of any existing viewer is detected as to whether there are at least two viewers and, if so, an indication signal is generated to the multimedia system to start playing, wherein the conditional parameter, i.e. the viewer number Nₐ, is 2 and it is determined whether the face detection number N_{f} is larger than or equal to 2. In another embodiment, a conditional parameter, e.g. the viewer number Nₐ, is 2 and a characteristic parameter is an eye detection number Nₑ and it is determined whether the eye detection number Nₑ corresponding to any existing viewers is larger than or equal to a percentage of the viewer number Nₐ so as to determine whether to request the multimedia system to start playing. In further embodiments, any other part of any detected existing face or any combination of parts of any detected existing face can be used as the basis to control the multimedia system, according to the above embodiments of controlling the multimedia system.

As such, the above embodiments of remote control can be referred to as “intelligent” remote control. That is, a remote-control system according to one or more of these embodiments can generate an indication signal, in response to detection results obtained in a situation, so as to control the operation of the multimedia device, without the need of giving direct commands by the user.

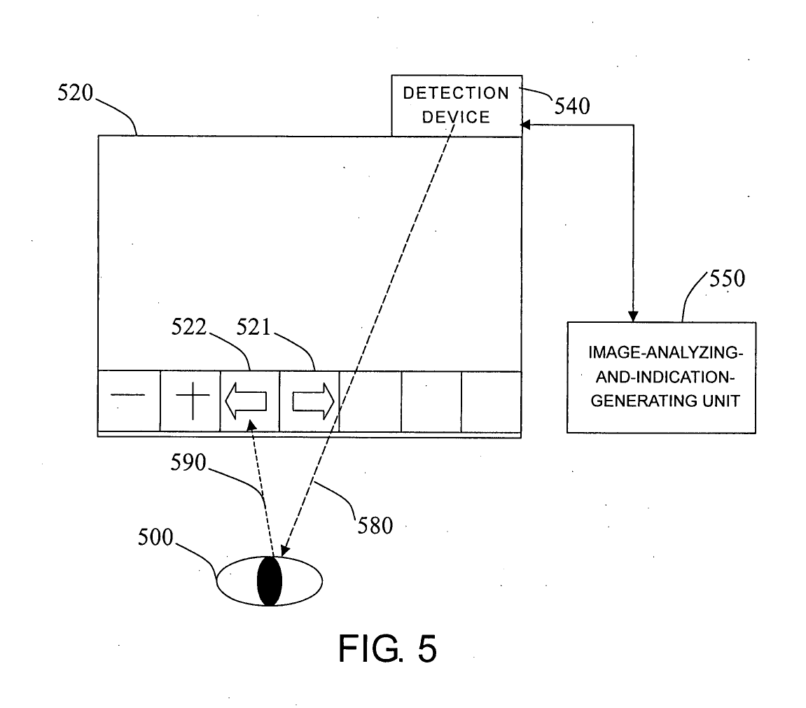

Moreover, another embodiment of the remote-control method according to the invention is shown, taking a menu mode as the operation mode of the multimedia system. Referring to FIG. 5, a face-detection-based remote-control system is applied to a multimedia system in a menu mode according to an embodiment of the invention.

When the multimedia system is in the menu mode, the display device 520 displays one or more options, called remote control options, for the user to select. The user needs to focus on one of the objects indicating the options for selection, such as a graph, image, block, region, or region of text. If the duration of eye focus satisfies a corresponding condition, e.g. the eye focus is on a remote control option for about a few seconds (e.g. 3 or more seconds), it indicates that the option is selected successfully.

In FIG. 5, a user is illustrated by an eye or eyeball 500, and the display device 520 displays remote control options, such as options 521 and 522.

Referring to FIGS. 3 and 5 for the sake of explanation of this embodiment, as indicated in step 310, an eye-focus-duration threshold T_{F0} is set as a conditional parameter and is associated with menu selection operations of the menu mode. As shown in step 320, any existing face and any eye of any existing face are detected to generate a face image signal, wherein the tracking technique for eye can also be used, such as eyeballs tracking and location. In step 330, according to the face image signal, any existing face and any eye of any existing face detected are analyzed to generate a plurality of characteristic parameters correspondingly. The characteristic parameters include an eye-focus-direction parameter indicating a direction of an eye focus (e.g. in spherical coordinates) and include an eye-focus-duration parameter indicating a duration of the eye focus T_{f}.

Next, in step 340, it is determined whether the direction of the eye focus points at a display screen of the display device 520. If so, a location at which the direction of the eye focus points is determined and whether the location corresponds to a remote control option on the display screen, such as the option 522 illustrated in FIG. 5, is then determined. If the direction of the eye focus points at a remote control option, it is then determined whether the duration of the eye focus is larger than or equal to the eye-focus-duration threshold T_{F0} (e.g. about 3 seconds) so as to generate a comparison result.

In step 350, if the comparison result in step 340 indicates affirmative, that is, the direction of the eye focus points at a remote control option and the duration of the eye focus T_{f} (e.g. about 3.7 seconds) Is larger than or equal to the eye-focus-duration threshold T_{F0} (e.g. about 3 seconds), an indication signal is generated, indicating that the remote control option is selected.

In step 340 of this embodiment, the detection device 540 and the image-analyzing-and-indication-generating unit 550 can determine the direction and distance from the detection device 540 to any detected face or eye, as illustrated by an arrow 580, and determine the direction of eye focus, as illustrated by an arrow 590. Further, whether the direction of eye focus points at one option on the display screen can be determined by table lookup or geometrical operations. For example, a look-up table is predetermined, indicating relationship between different directions of eye focus (e.g. in angles) and different regions on the display screen (e.g. in numbers) so as to determine a region on the display screen corresponding to a direction of an eye focus through table lookup.

According to the embodiment of the remote-control method in the menu mode, there are various applications can be developed as follows.

For example, when the eyeball focuses on an option for “next” or “previous” over the eye-focus-duration threshold T_{F0}, an indication signal is generated, indicating start changing the current display screen, such as a video program or a song, to a next section or a previous section and continuing such change until a next remote control option is executed. When the eyeball focuses on a location not corresponding to any remote control option, this operation stops.

When the eyeball focuses on an option for “forward” or “backward”, as illustrated by the option 521 or 522, over or equal to the eye-focus-duration threshold T_{F0}, an indication signal is generated, indicating start performing the “forward” or “backward” operation and speeding up the “forward” or “backward” operation if the eyeball still focuses on the same option after performing this operation. The operation selected continues until a next remote control option is executed or when the eyeball focuses on a location not corresponding to any remote control option, this operation stops.

When the eyeball focuses on a sound volume option, as illustrated by a plus sign “+” in FIG. 5, for or over the eye-focus-duration threshold T_{F0}, the multimedia system starts increasing the volume (or decreasing the volume by the focusing of a minus sign “−”). The operation selected continues until a next remote control option is executed or when the eyeball focuses on a location not corresponding to any remote control option, this operation stops.

According to the invention, eye tracking can also be used in controlling the menu. For example, if there are 10 remote control options and the display screen can only display 5 of them for one time. Turning to another page of the menu can be performed by the eye tracking technique. In addition, when playing the multimedia contents, the remote control options can be closed or hidden by the eye tracking technique.

Moreover, for implementation, in the various embodiments of the remote-control method, such as steps 330 to 350 or corresponding steps can be implemented as software such as a program or program functions, operative with a database or data structures for recording relationship among conditional parameters, remote control operations, and related associations. In addition, the embodiments of the invention can also be implemented by hardware or firmware, or any combination of thereof.

In the face-detection-based remote-control system and method and face-detection-based remote-controllable multimedia system according to the above various embodiments of the invention, behavior of at least some part of a human body is associated with operations for remotely controlling the multimedia system and an indication signal is generated based on such association and outputted to the multimedia system, thereby changing the operation or behavior of the multimedia system. As such, the multimedia system can be controlled more easily and directly. In addition, an intelligent remote-control method can be developed according to the invention and applied in a remote-control system to generate an indication signal, in response to detection results obtained in a situation, so as to control the operation of the multimedia device, without the need of giving direct commands by the user.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A face-detection-based remote-control method for a multimedia system, the multimedia system for playing multimedia data, the method comprising:
(a) detecting at least one part of any existing face by using a detection device according to an operation mode of the multimedia system in order to generate a face image signal;
(b) analyzing at least the part of the detected existing face according to the face image signal to generate at least a characteristic parameter correspondingly;
(c) comparing at least the characteristic parameter to at least a conditional parameter to generate a comparison result, wherein the conditional parameter is associated with at least one control operation of the operation mode; and
(d) generating at least an indication signal to the multimedia system according to the comparison result.

2. The method according to claim 1, wherein the operation mode is a playing mode, the at least one control operation of the operation mode includes a playing operation associated with the conditional parameter and indicating that the multimedia system plays the multimedia data.

3. The method according to claim 2, wherein existing face detection is performed in step (a) to generate the face image signal accordingly; and the characteristic parameter generated in step (b) corresponds to any face detected in step (a) and includes a face detection number indicating how many faces are detected.

4. The method according to claim 2, wherein eye detection is performed in step (a) to generate the face image signal accordingly; and the characteristic parameter generated in step (b) corresponds to eyes of any face detected in step (a) and includes an eye detection number indicating how many eyes that are opened are detected.

5. The method according to claim 2, wherein existing face detection and eye detection are performed in step (a) to generate the face image signal accordingly; and the characteristic parameters generated in step (b) correspond to any face detected in step (a) and eyes of any face detected in step (a) and include a face detection number indicating how many faces are detected and an eye detection number indicating how many eyes that are opened are detected.

6. The method according to claim 5, wherein whether the face detection number is larger than or equal to a percentage of the conditional parameter and whether the eye detection number is larger than or equal to an another percentage of the conditional parameter are detected in step (c).

7. The method according to claim 6, wherein if the comparison result generated in step (c) is affirmative, the indication signal generated in step (d) indicates performing the playing operation.

8. The method according to claim 1, wherein the operation mode is a menu mode, the at least one control operation of the operation mode includes a menu selection operation associated with the conditional parameter and indicating setting or controlling the multimedia system.

9. The method according to claim 8, wherein at least one eye detection is performed in step (a) to generate the face image signal accordingly; and the characteristic parameters generated in step (b) correspond to any eye of any face detected in step (a) and include an eye-focus-direction parameter indicating a direction of an eye focus and include an eye-focus-duration parameter indicating a duration of the eye focus.

10. The method according to claim 9, wherein step (c) comprises determining whether the direction of the eye focus points at a remote control option of a display screen of the multimedia system and determining whether the eye-focus-duration parameter is larger than or equal to the conditional parameter so as to generate the comparison result, wherein the conditional parameter is an eye-focus-duration threshold.

11. The method according to claim 10, wherein in step (d), if the comparison result in step (c) is affirmative, the indication signal generated in step (d) indicates that the remote control option is selected.

12. A face-detection-based remote-control system for a multimedia system, the multimedia system having an operation mode, the operation mode having a control operation, the remote-control system comprising:
a detection device for detecting at least one part of any existing face according to the operation mode in order to generate a face image signal;
an image-analyzing-and-indication-generating unit, coupled to the detection device, for analyzing at least the part of the detected existing face according to the face image signal to generate at least a characteristic parameter correspondingly, and for comparing at least the characteristic parameter to at least a conditional parameter to generate a comparison result, and for generating at least an indication signal to the multimedia system according to the comparison result, wherein the conditional parameter is associated with at least one control operation of the operation mode.

13. The remote-control system according to claim 12, wherein the operation mode is a playing mode, the at least one control operation of the operation mode includes a playing operation associated with the conditional parameter and indicating that the multimedia system plays the multimedia data.

14. The remote-control system according to claim 13, wherein the detection device detects any existing face to generate the face image signal accordingly; and the characteristic parameter generated by the image-analyzing-and-indication-generating unit corresponds to any face detected by the detection device and includes a face detection number indicating how many faces are detected.

15. The remote-control system according to claim 14, wherein the image-analyzing-and-indication-generating unit generates the indication signal indicating performing the playing operation if the comparison result indicates that the face detection number is larger than or equal to the conditional parameter.

16. The remote-control system according to claim 13, wherein the detection device detects at least any eye of any existing face to generate the face image signal accordingly; and the characteristic parameter generated by the image-analyzing-and-indication-generating unit corresponds to any face detected by the detection device and includes an eye detection number indicating how many eyes that are opened are detected.

17. The remote-control system according to claim 16, wherein the image-analyzing-and-indication-generating unit generates the indication signal indicating performing the playing operation if the comparison result indicates that the eye detection number is larger than or equal to the conditional parameter.

18. The remote-control system according to claim 12, wherein the operation mode is a menu mode, the at least one control operation of the operation mode includes a menu selection operation associated with the conditional parameter and indicating setting or controlling the multimedia system.

19. The remote-control system according to claim 18, wherein the detection device detects at least any eye of any existing face to generate the face image signal accordingly; and the characteristic parameters generated by the image-analyzing-and-indication-generating unit correspond to any eye of any face detected and include an eye-focus-direction parameter indicating a direction of an eye focus and include an eye-focus-duration parameter indicating a duration of the eye focus.

20. The remote-control system according to claim 12, wherein the image-analyzing-and-indication-generating unit includes a microprocessor.

21. The remote-control system according to claim 12, wherein the detection device is a digital image acquisition device.

22. A face-detection-based remote-controllable multimedia system, the multimedia system having an operation mode, the operation mode having a control operation, the multimedia system comprising:
a detection device for detecting at least one part of any existing face according to the operation mode in order to generate a face image signal;
an image-analyzing-and-indication-generating unit, coupled to the detection device, for analyzing at least the part of the detected existing face according to the face image signal to generate at least a characteristic parameter correspondingly, and for comparing at least the characteristic parameter to at least a conditional parameter to generate a comparison result, and for generating at least an indication signal to the multimedia system according to the comparison result, wherein the conditional parameter is associated with at least one control operation of the operation mode; and
a playing device for playing multimedia data according to at least one indication signal.

23. The multimedia system according to claim 22, further comprising a display device for displaying at least one remote control option, wherein the operation mode is a menu mode, the at least one control operation of the operation mode includes a menu selection operation associated with the conditional parameter and the at least one remote control option.

24. The multimedia system according to claim 23, wherein the detection device detects at least any eye of any existing face to generate the face image signal accordingly; and the characteristic parameters generated by the image-analyzing-and-indication-generating unit correspond to any eye of any face detected in step (a) and include an eye-focus-direction parameter indicating a direction of an eye focus and include an eye-focus-duration parameter indicating a duration of the eye focus.

25. The multimedia system according to claim 24, wherein the image-analyzing-and-indication-generating unit determines whether the direction of the eye focus points at one of the at least one remote control option and determines whether the duration of the eye focus is larger than or equal to the conditional parameter so as to generate the comparison result, wherein the conditional parameter is an eye-focus-duration threshold.

26. The multimedia system according to claim 25, wherein the image-analyzing-and-indication-generating unit generates the indication signal indicating that the remote control option is selected if the comparison result is affirmative.

27. The multimedia system according to claim 22, wherein the operation mode is a playing mode, the at least one control operation of the operation mode includes a playing operation associated with the conditional parameter and indicating that the multimedia system plays the multimedia data.

28. The multimedia system according to claim 27, wherein the detection device detects any existing face to generate the face image signal accordingly; and the characteristic parameter generated by the image-analyzing-and-indication-generating unit corresponds to any face detected by the detection device and includes a face detection number indicating how many faces are detected.

29. The multimedia system according to claim 28, wherein the image-analyzing-and-indication-generating unit generates the indication signal indicating performing the playing operation if the comparison result indicates that the face detection number is larger than or equal to the conditional parameter.

30. The multimedia system according to claim 27, wherein the detection device detects at least any eye of any existing face to generate the face image signal accordingly; and the characteristic parameter generated by the image-analyzing-and-indication-generating unit corresponds to any face detected by the detection device and includes an eye detection number indicating how many eyes that are opened are detected.

31. The multimedia system according to claim 30, wherein the image-analyzing-and-indication-generating unit generates the indication signal indicating performing the playing operation if the comparison result indicates that the eye detection number is larger than or equal to the conditional parameter.
